(19) United States
(12) Patent Application Publication
(10) Pub. No.: US 2013/0120213 A1
(43) Pub. Date: May 16, 2013

(54) BROADBAND ANTENNA SYSTEMS AND METHODS

(71) Applicant: Utah State University, North Logan, UT (US)

(72) Inventors: Bedri A. Cetiner, Logan, UT (US); Hema Swaroop Mopidevi, Logan, UT (US); Daniel Rodrigo, Barcelona (ES); Luis Jofre, Barcelona (ES)

(73) Assignee: Utah State University, North Logan, UT (US)

(21) Appl. No.: 13/674,298

(22) Filed: Nov. 12, 2012

Related U.S. Application Data
(60) Provisional application No. 61/558,976, filed on Nov. 11, 2011.

(51) Int. Cl. H01Q 1/48; H01Q 21/00; H01Q 1/38

(52) U.S. Cl. CPC H01Q 1/48; H01Q 1/38; H01Q 21/00
USPC 343/846

(57) ABSTRACT

A multi-band antenna that may be designed to operate well in both Public Safety (PS) and Long-Term Evolution (LTE) wireless communication may employ a stepped T-shape structure in conjunction with patch tapering or a reconfigurable ground plane architecture and capacitive feeding to achieve broad bandwidth performance (e.g., over a frequency range from 220 MHz to 4900 MHz). To achieve desired performance, the antenna may include a three-dimensional structure having lateral dimensions of approximately 0.25λ in length and 0.01λ in height at a low desired frequency of operation (e.g., 426 MHz). In some embodiments, the disclosed antenna may exhibit good gain flatness and have a radiation pattern that remains substantially constant over a broad range of operating frequencies.

### CROSS-REFERENCE TO RELATED APPLICATIONS

This application claims the benefit of U.S. Provisional Application No. 61/558,976, filed Nov. 11, 2011, which is hereby incorporated by reference herein in its entirety.

### STATEMENT REGARDING FEDERALLY SPONSORED RESEARCH

The technology described in this application was developed in part by Award No. 2007-IJCX-K025 and Award No. 2009-SQ-B9-K005, awarded by the National Institute of Justice, Office of Justice Programs, U.S. Department of Justice. The government has certain rights in the claimed invention.

### TECHNICAL FIELD

The present disclosure relates generally to broadband antennas and, more specifically, to a multi-band reconfigurable antenna with a high operational frequency ratio.

### SUMMARY

In embodiments, a broadband antenna includes a top patch having a top metallization layer, a capacitor patch, and a top patch substrate between the top metallization layer and the capacitor patch; a T-shaped ground layer disposed below the top patch; and a ground wall electrically coupling the top metallization layer with the T-shaped ground layer.

In other embodiments, the T-shaped ground layer is reconfigurable; the top metallization layer may include a U-shaped slit or a linear taper.

In another embodiment, the broadband antenna includes a second antenna disposed between the top patch and the T-shaped ground layer; and the second antenna includes a second top patch, wherein the capacitor patch provides the second top patch; a monopole-shaped ground layer; and a second ground wall electrically coupling the second top patch with the monopole-shaped ground layer.

In embodiments, the dielectric material comprises a substrate material having a dielectric constant in the range of ∈ᵣ=3.38 to ∈ᵣ=3.55. The broadband antenna may be configured to be fed by a coaxial cable having an inner conductor electrically coupled with the capacitor patch and an outer conductor electrically coupled to the T-shaped ground layer. The broadband antenna may be configured to operate in standard public safety wireless communication bands. The broadband antenna may be configured to operate in standard long-term evolution wireless communication bands. The broadband antenna may be configured to operate from 221 MHz to 861 MHz. Additionally, the second antenna may be configured to operate at 4.9 GHz.

In another embodiment, a broadband antenna includes a top patch having a top metallization layer, a capacitor patch, and a top patch substrate between the top metallization layer and the capacitor patch; a reconfigurable ground layer including a microelectromechanical switch to activate portions of the reconfigurable ground layer; a shorting wall electrically coupling the top patch with the reconfigurable ground layer, wherein the top patch is fed by a capacitive feed comprising a coaxial cable coupled with the capacitor patch.

The broadband antenna may further include a second antenna disposed between the top patch and the reconfigurable ground layer, the second antenna including: a second top patch, wherein the capacitor patch provides the second top patch; a monopole shaped ground layer; and a second ground wall electrically coupling the second top patch with the monopole shaped ground layer.

In another embodiment, a broadband antenna may include a top patch; a T-shaped ground layer disposed below the top patch; and a ground wall electrically coupling the top metallization layer with the T-shaped ground layer, wherein the top patch, the T-shaped ground layer, and the ground wall are configured to create a resonant frequency in multiple bands. The T-shaped ground layer may be configured to behave as a quarter-wave monopole at a first frequency and a second frequency. In embodiments, the first frequency may be 390 MHz, in another embodiment, the second frequency may be 585 MHz. In another embodiment, an active component may be configured to reconfigure the ground layer to produce additional resonant frequencies.

In another embodiment, the broadband antenna may also include a second antenna disposed between the top patch and the T-shaped ground layer, the second antenna configured to produce an additional resonant frequency.

### BRIEF DESCRIPTION OF THE DRAWINGS

FIGS. 1A and 1B illustrate an example of a broadband antenna having a stepped T-shape architecture.

FIG. 2 illustrates an example plot of reflection coefficients of a stepped T-shape antenna in comparison with a conventional straight T-shape antenna over a broad frequency range.

FIGS. 3A and 3B illustrate surface current plots of an example broadband antenna having a stepped T-shape architecture.

FIGS. 4A and 4B illustrate example plots of reflection coefficients over varied dimensions of parameters L₁ and L₂ of the example stepped T-shape architecture.

FIG. 5 illustrates a two-dimensional schematic of an example stepped T-shape architecture antenna showing design parameters.

FIG. 6 illustrates an example plot of measured and simulated reflection coefficients of an example stepped T-shape antenna.

FIGS. 7A-7J illustrate example plots of simulated and measured radiation patterns of an example stepped T-shape antenna at different operating frequencies.

FIG. 8 illustrates a plot of simulated and measured gains and efficiencies of an example stepped T-shape antenna.

FIGS. 9A and 9B illustrates an example of a broadband antenna having a reconfigurable ground plane architecture.

FIGS. 10A-10C illustrate a two-dimensional layout of the various components an example broadband antenna having a reconfigurable ground plane architecture.

### DETAILED DESCRIPTION

Radio frequency spectrum is a naturally limited resource that is in high demand. Much of this demand is driven by proliferation of next generation communication services offering mobile multi-media applications and services over mobile broadband networks. The Universal Mobile Telecommunications System (UMTS) Long Term Evolution (LTE) wireless standard is well suited for these applications in view of its ability to interconnect with other access technologies and provide interoperable mobile wireless communication with spectral efficiency. This type of robust communication is also important when utilizing mobile communication platforms to respond to emergency situations. For example, in response to natural disasters or other emergency situations, emergency responders (e.g., police, firefighters, emergency medical services) may utilize U.S. Public Safety (PS) wireless communication bands to coordinate response efforts.

Emergency responders are often equipped with wireless laptops, handheld computers, mobile video cameras, and/or other mobile devices to aid in response efforts. For example, in responding to emergency situations, emergency responders may utilize a variety of broadband wireless services including, for example, e-mail, web browsing, database access, and video streaming, in conjunction with other basic communication services (e.g., voice and messaging). Consistent with embodiments disclosed herein, a compact broadband antenna for mobile devices designed to operate well in both PS and LTE wireless communication bands may be used effectively to meet such varied communication demands.

The systems and methods introduced here provide for a multi-band antenna designed to operate well in both PS and LTE wireless communication. In some embodiments, the disclosed antenna may employ a stepped T-shape structure in conjunction with patch tapering or a reconfigurable ground plane architecture and capacitive feeding to achieve broad bandwidth performance (e.g., over a frequency range from 220 MHz to 4900 MHz). To achieve desired performance, the antenna may in certain embodiments employ a three-dimensional structure having lateral dimensions of approximately 0.25λ in length and 0.01λ in height at a low desired frequency of operation (e.g., 426 MHz). In some embodiments, the disclosed antenna may exhibit good gain flatness and have a radiation pattern that remains substantially constant over a broad range of operating frequencies.

In certain embodiments, the disclosed broadband antenna may employ a stepped T-shape architecture. This novel architecture may create a dual resonance behavior caused by the excitation of two monopole-like structures included in the design. Utilizing this dual resonance behavior may substantially increase (e.g., double) the bandwidth of the disclosed antenna structure. In certain embodiments, the dual resonance behavior may be achieved without active circuitry. In other embodiments, the disclosed broadband antenna may employ active circuitry and a reconfigurable ground plane and a second antenna structure to provide extended bandwidth capability.

Stepped T-Shape Architecture

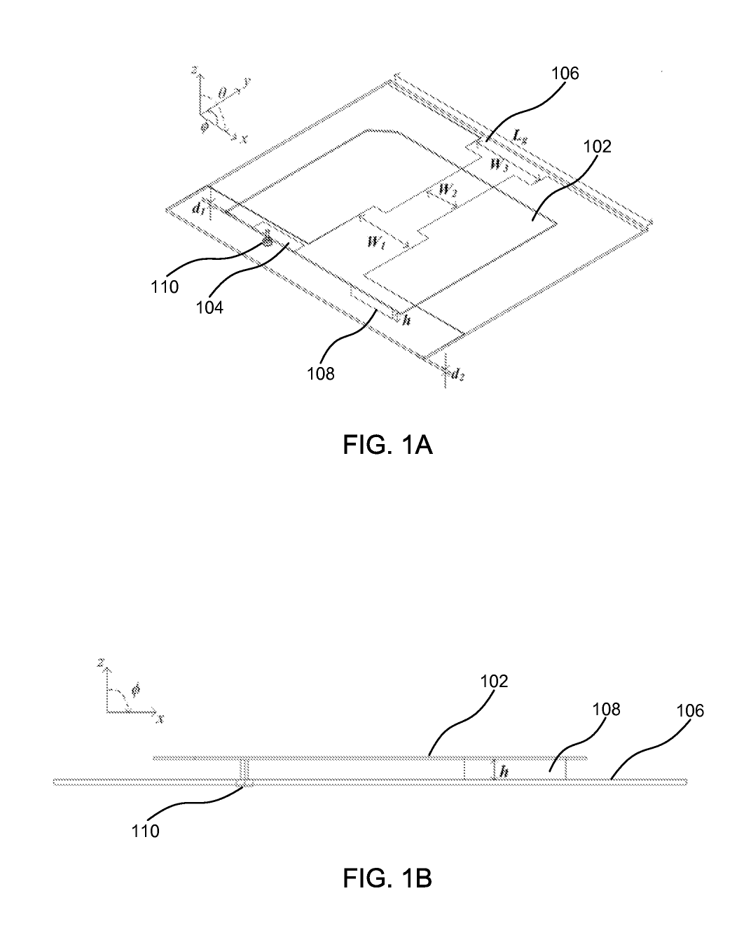

FIGS. 1A and 1B show an example of a broadband antenna having a stepped T-shape architecture consistent with embodiments disclosed herein. As illustrated, the antenna may include a top patch 102, a capacitive feed 104, a stepped T-shape structure 106, and a shorting wall 108. In certain embodiments, the capacitance of the capacitive feed may be achieved using a metal-insulator-metal structure, which may be formed, for example, by the top patch metallization, a dielectric material (e.g., RO4003C™ substrate material having a dielectric constant or static relative permittivity of approximately ∈ᵣ=3.55 manufactured by Rogers Corporation™), and a bottom capacitor metallization (i.e., a capacitor patch). The broadband antenna may be fed by a coaxial cable 110 having its inner and outer conductors electrically coupled (e.g., soldered) to the capacitor patch and the stepped T-shape structure, respectively. Further, the shorting wall 108 may be electrically coupled (e.g., soldered) to the top patch 102 on one end and to the stepped T-shape structure 106 on the other.

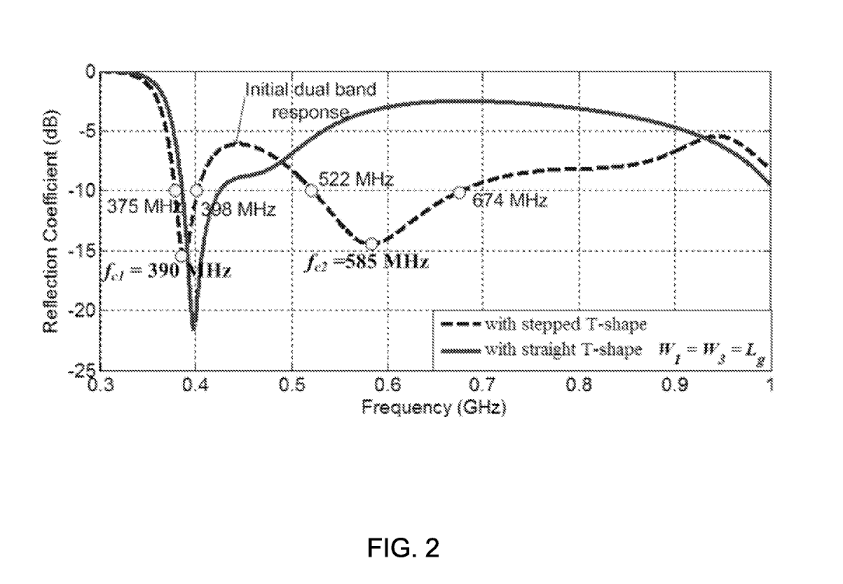

FIG. 2 illustrates an example plot of reflection coefficients of a stepped T-shape antenna in comparison with a conventional straight T-shape antenna over a broad frequency range. As discussed above, the stepped T-shape architecture of the disclosed antenna may exhibit a dual resonance behavior as shown in FIG. 2. Particularly, the example plot of FIG. 2 illustrates reflection coefficients of a stepped T-shape antenna consistent with embodiments disclosed herein in comparison with a conventional straight T-shape antenna over a broad frequency range. As shown, the example stepped T-shape antenna of FIG. 1 behaves as a λ/4 monopole at two frequencies (i.e. at approximately 390 MHz and 585 MHz). In certain embodiments, the stepped T-shape antenna structure may be optimized using patch tapering and capacitive coupled feed methods. In certain embodiments, this optimization may result in a wideband performance of 68%, as discussed in more detail below.

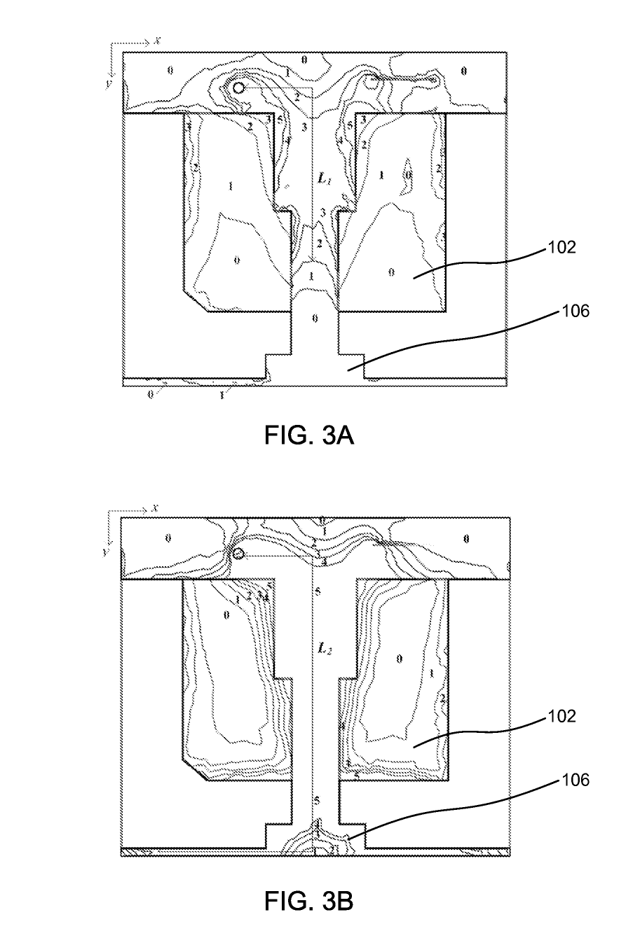

FIGS. 3A and 3B illustrate surface current plots of an example broadband antenna having a stepped T-shape architecture. As shown in FIG. 3A, the example stepped T-shape structure shown in FIG. 1 may behave as a λ/4 monopole at a particular frequency (e.g., 585 MHz) with the top patch functioning as a ground plane. In certain embodiments, parameter L₁ illustrated in FIG. 3A may be a quarter wavelength at 585 MHz, resulting in an impedance match from approximately 522 MHz to 674 MHz. Similar behavior is illustrated in FIG. 3B, showing monopole behavior with parameter L₂ being a quarter wavelength at 390 MHz, resulting in an impedance match from approximately 375 MHz to 398 MHz.

Parameters W₁ and W₂ illustrated in FIG. 1 may be varied to broaden the bandwidth of the antenna. Further, parameters I₃ and W₃ may be varied to improve the impedance match of the antenna. Parameters L_{s=1 to 2} and I_{s=1 to 3} may be mathematically related as follows: L₁˜g+W₁/2+I₁+I₂/3; L₂˜g+W₁/2+I₁+I₂+I₃+L_{g}/2, where g is measured as the distance in the x-direction from the coaxial feeding point location of the antenna to the edge of the pole structure.

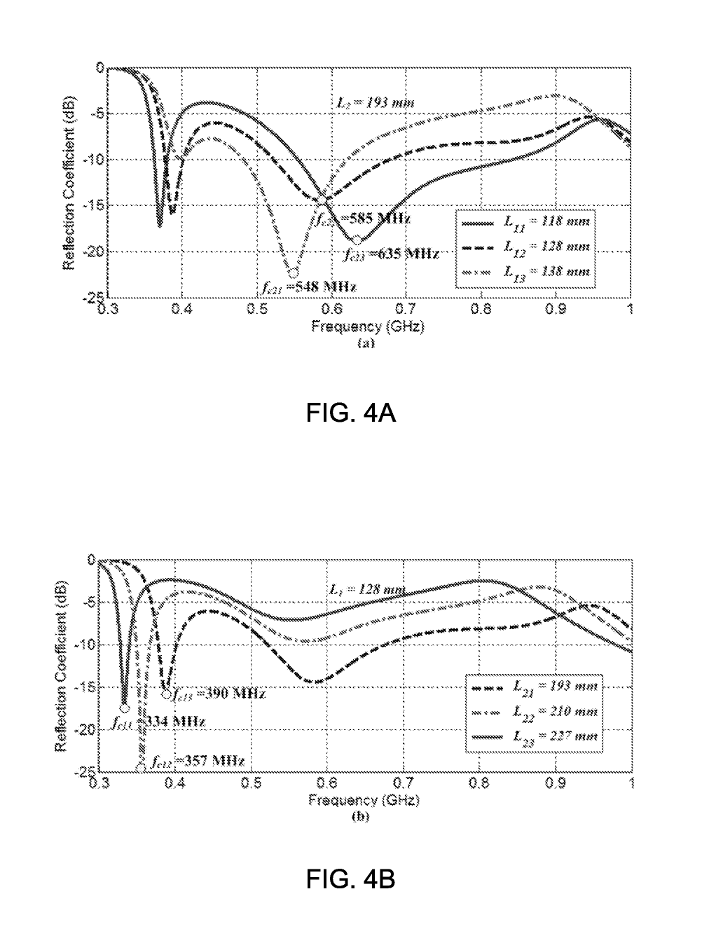

As with many antenna structures, varying the dimensions of certain parameters may affect the performance of the antenna. FIGS. 4A and 4B illustrate example plots of reflection coefficients over varied dimensions of parameters L₁ and L₂ of the example stepped T-shape architecture. Reflection coefficients exhibited by the antenna over varied dimensions of parameters L₁ and L₂ show the dual monopole behavior of the stepped T-shape structure. FIG. 4A illustrates an example plot of reflection coefficients over varied dimensions of parameter L₁ (e.g., L₁ of 118 mm, 128 mm, and 138 mm) while keeping L₂ fixed (e.g., L₂ of 193 mm). Varying L₁ while keeping L₂ fixed may change the higher resonance frequency f_{c2} (e.g., f_{c2} of 548 MHz, 585 MHz, and 635 MHz) with little change of the lower resonance frequency f_{c1} (e.g., f_{c1} of 390 MHz). In certain embodiments, the varied dimensions of parameter L₁ may correspond to λ/4 monopole lengths at the varied higher resonance frequencies f_{c2}.

FIG. 4B illustrates an example plot of reflection coefficients over varied dimensions of parameter L₂ (e.g., L₁ of 193 mm, 210 mm, and 227 mm) while keeping L₁ fixed (e.g., L₂ of 128 mm). As shown, varying L₂ while keeping L₁ fixed may control the lower resonance frequency f_{c1} with little change of the higher resonance frequency f_{c2}. Increasing L₂, however, may negatively impact input matching of the antenna at the higher resonance frequency f_{c2}. In certain embodiments, the varied dimensions of parameter L₂ may correspond to λ/4 monopole lengths at the varied lower resonance frequencies f_{c1}.

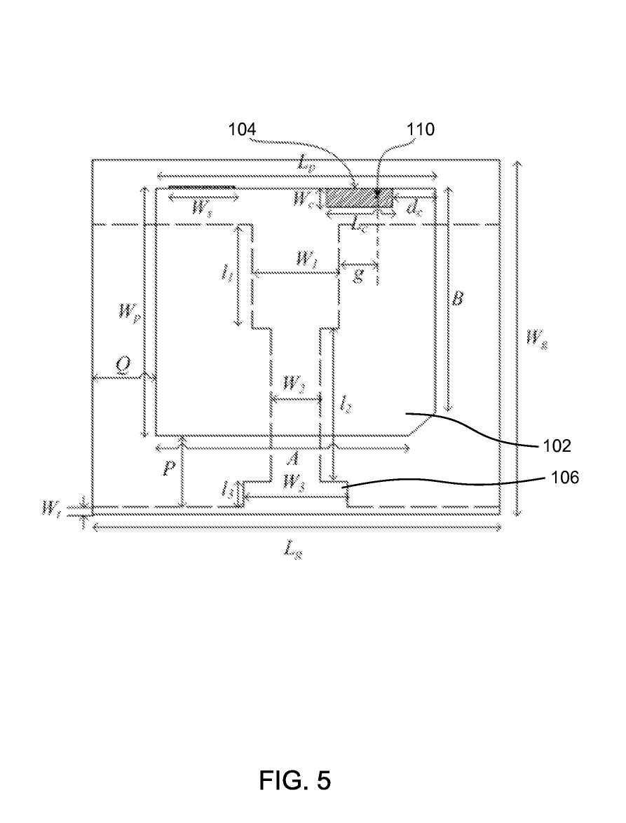

In some embodiments, to enhance bandwidth of the antenna, the top patch 102 may include a linear taper. FIG. 5 illustrates a two-dimensional schematic of an example stepped T-shape architecture antenna showing design parameters including a linear taper. Particularly, as illustrated, parameters used in designing the linear taper include: A, B, Lₚ, and Wₚ.

To implement a capacitive feed 104 that compensates for the inductance effect of the coaxial feed 110, a substrate (e.g., a RO4003C™ substrate having a thickness of approximately 0.8 mm) may be sandwiched between the bottom conductive plate of the bottom capacitor metallization (i.e., capacitor patch/capacitive feed) and the top patch metallization of the antenna. As illustrated in FIG. 5, parameters used in designing the capacitive feed include L_{c} and W_{c}, corresponding to the size of the capacitor patch, and d_{c}, corresponding to the location of the capacitor patch.

Referring to the parameters shown in FIG. 1 and FIG. 5, the example stepped T-shape antenna design consistent with embodiments disclosed herein may have the following design parameters: top patch, Lₚ×Wₚ=132.5 mm×117.5 mm; the location of the top patch, Q=30.6 mm and P=33.9 mm; the substrate thickness of the top patch, d₁=0.813 mm; the tapering lengths, A=119.9 mm and B=106.8 mm; the stepped T-shape structure parameters, W₁=41.25 mm, W₂=23.75 mm, W₃=49.7 mm, I₁=49.3 mm, I₂=72.8 mm, I₃=12 mm, Wₜ=3.75 mm, g=17 mm; the capacitor patch, L_{c}×W_{c}=31.25 mm×8.75 mm and d_{c}=20 mm; the width of the shorting wall Wₛ=31.25 mm; the substrate size of the stepped T-shape structure, L_{g}×W_{g}=193.75 mm×168.75 mm; the substrate thickness of the stepped T-shape structure, d₂=1.525 mm; and the height of the antenna, h=7 mm.

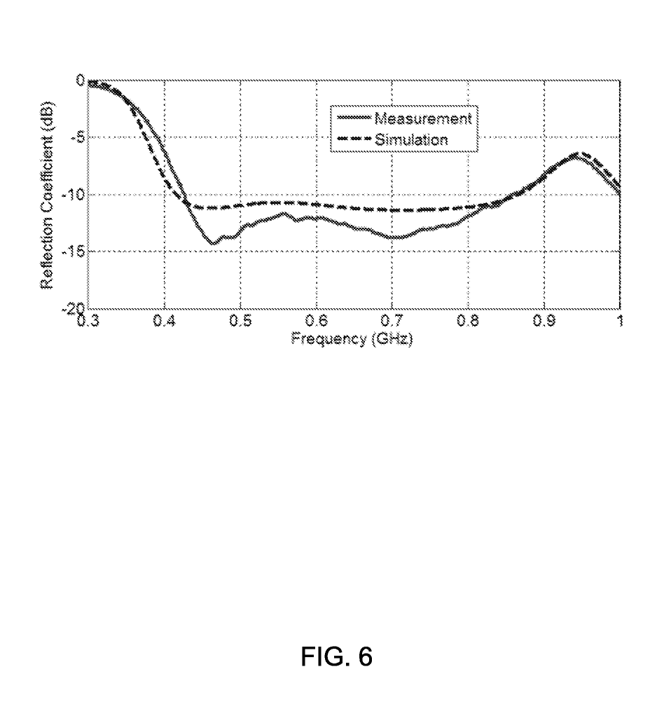

FIG. 6 illustrates an example plot of simulated and measured reflection coefficients of the above-described stepped T-shape antenna. As illustrated, the example stepped T-shape antenna exhibits a wideband performance of 68% over a frequency range of 426 MHz to 861 MHz for VSWR <2.

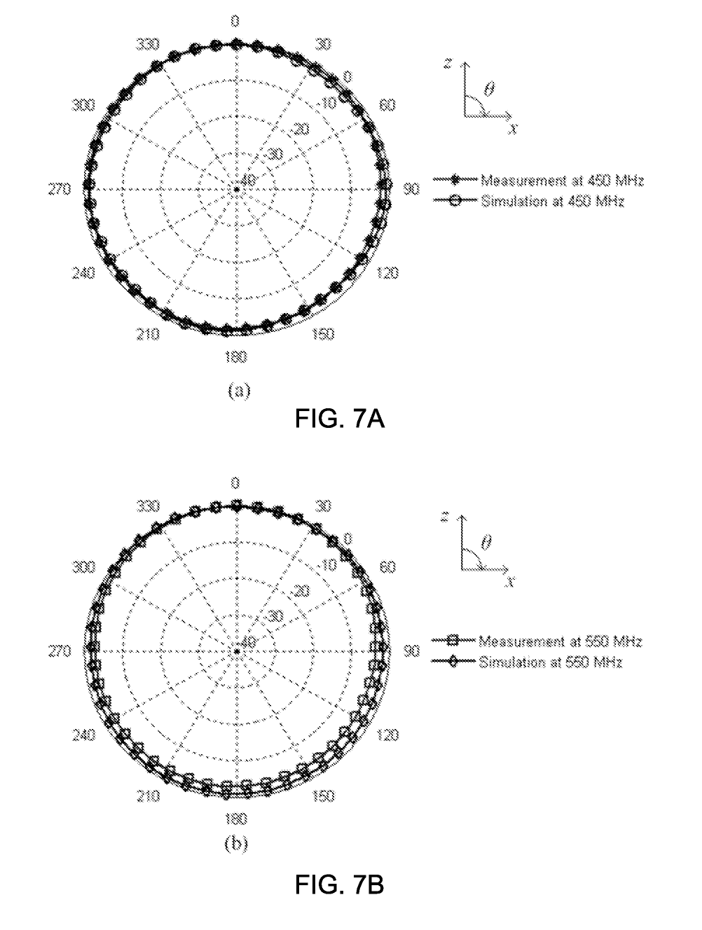

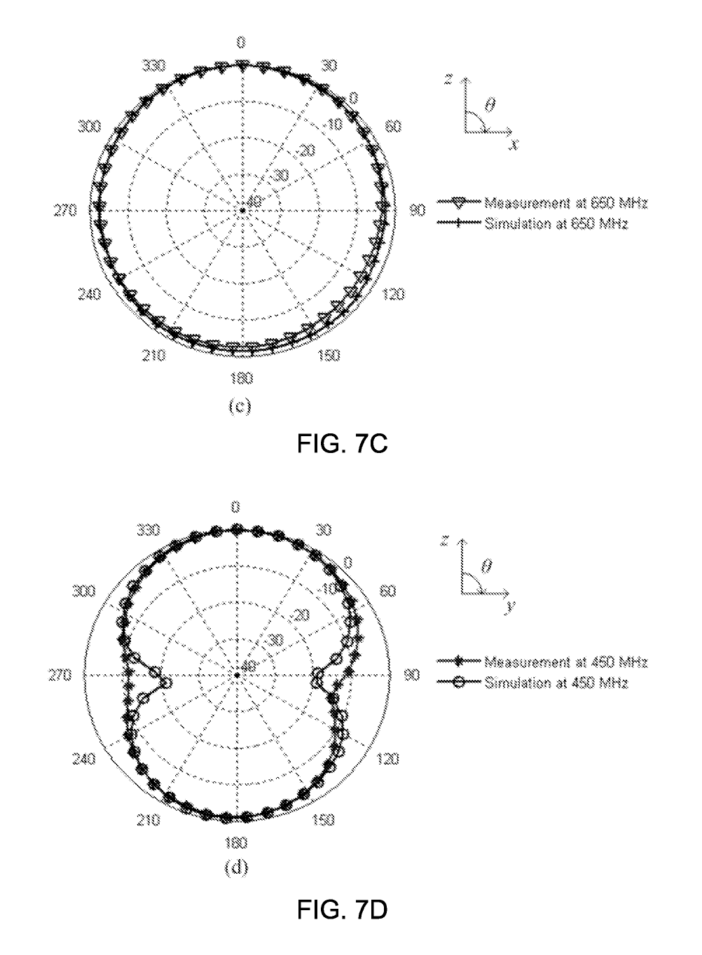

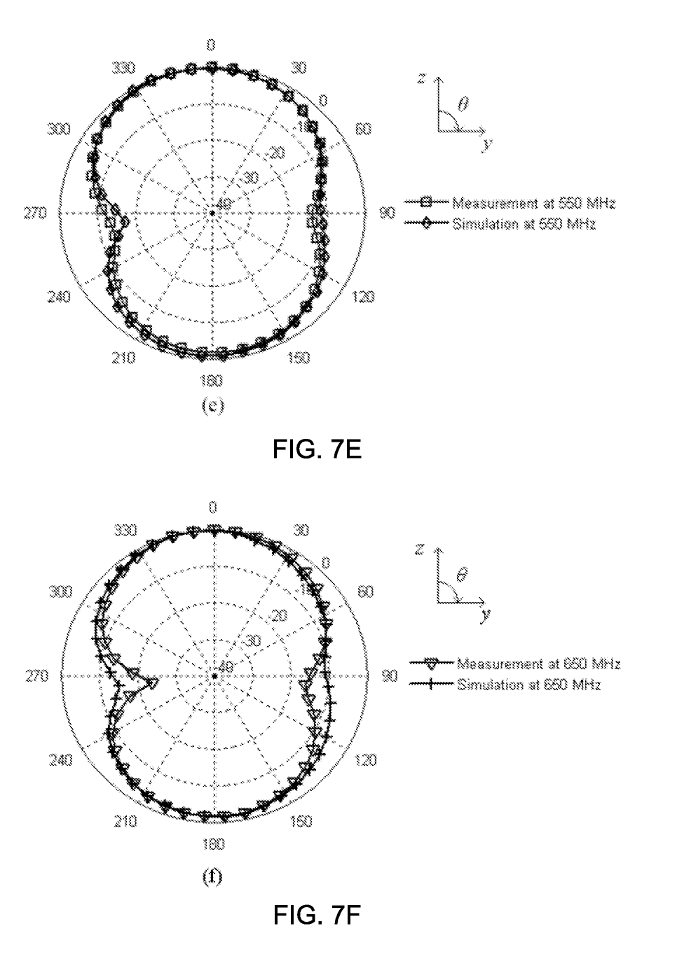

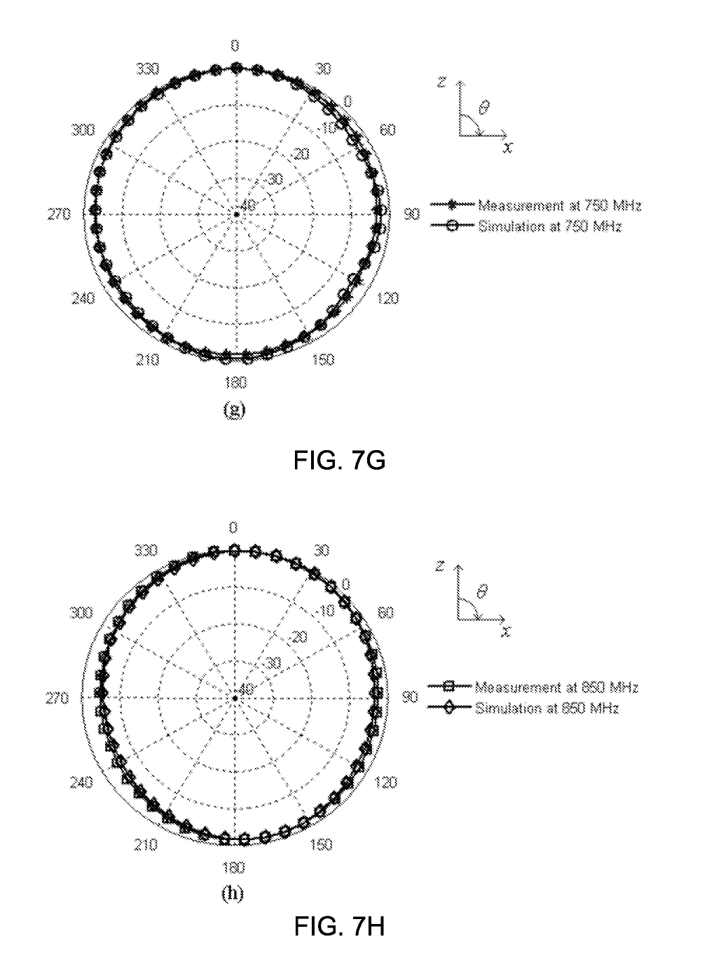

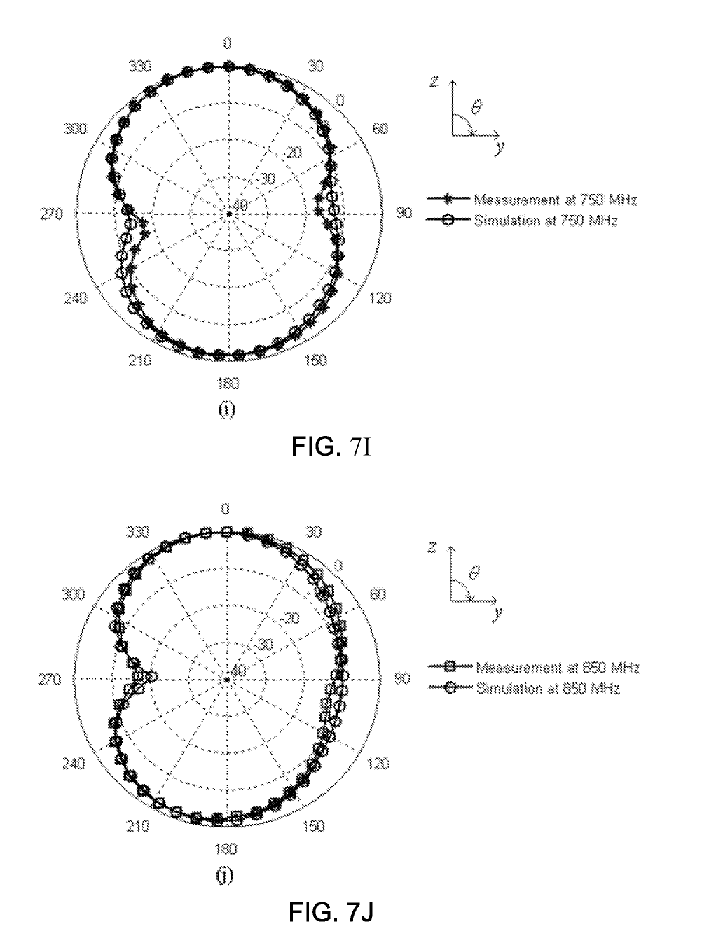

FIGS. 7A-7J illustrate example plots of simulated and measured radiation patterns showing the normalized total electric field intensity in the x-z and y-z planes at 450, 550, 650, 750, and 850 MHz. As illustrated, the radiation patterns are omni-directional, being generally uniform over the x-y plane and directional over the y-z plane, due in part to the surface currents having y-direction orientation and being condensed in the central section of the stepped T-shape structure. The measured radiation patterns illustrate that the example stepped T-shaped antenna maintains radiation pattern integrity over a broad frequency band from 426 MHz to 861 MHz.

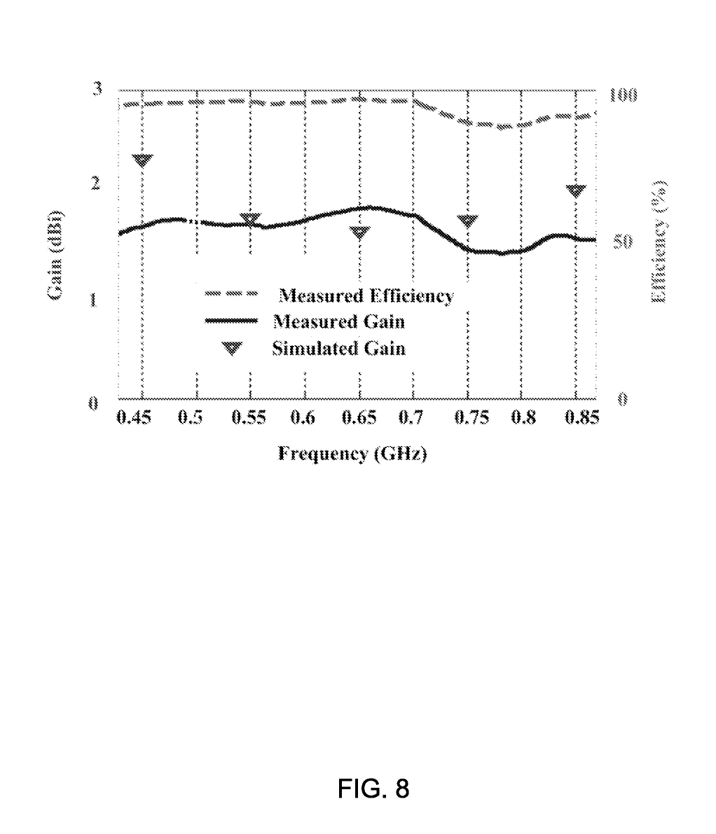

FIG. 8 illustrates an example plot of measured efficiencies of the above-described example stepped T-shape antenna. As illustrated, over a broad frequency band from 426 MHz to 861 MHz, the example stepped T-shaped antenna maintains the integrity of the radiation pattern, is highly efficient (i.e., approximately 90%), and maintains good gain flatness with an average gain of approximately 2 dBi. The flat gain and consistent radiation patterns exhibited by the example stepped T-shape antenna indicate strong performance reliability, desirable for an antenna configured to operate in the PS wireless bands.

Reconfigurable Ground Layer Architecture

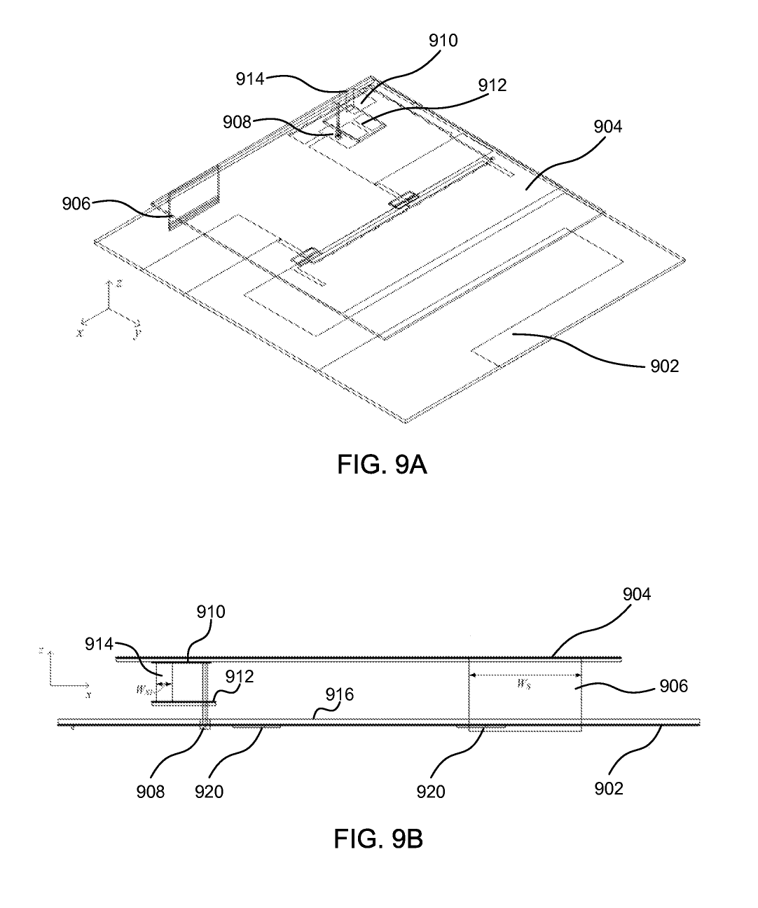

The multi-band response desired for communication in both the PS and UMTS LTE (or other cellular communication) band may also be achieved by employing a reconfigurable T-shape antenna architecture. FIGS. 9A and 9B illustrate an example of a broadband antenna having a reconfigurable ground plane architecture. In addition to the reconfigurable T-shape antenna architecture, the example of FIGS. 9A and 9B includes an additional small monopole antenna configured to operate it the 4.9 GHz PS band. FIG. 9A illustrates a three-dimensional perspective of the example antenna. FIG. 9B illustrates a side view of the example antenna. As shown in FIGS. 9A and 9B, the example antenna structure includes two antennas fed by a single coaxial cable. The first antenna includes a reconfigurable ground layer 902, a top patch layer with U shaped slit 904, a ground wall 906, a coaxial feed 908 and a capacitor patch 910 (together the coaxial feed and the capacitor patch provide a capacitive feed for the antenna). The ground layer may be reconfigurable by activating switches 920, as show in FIG. 9B. In one embodiment, the switches may be radio frequency microelectromechanical systems (MEMS). As shown in FIG. 9B, the metallization of the reconfigurable ground layer may be disposed on the opposite side of the substrate 916 from the top patch to provide better integration of the MEMS switches. However, the reconfigurable ground layer may also be disposed on the top layer according to design choice. The dimensions of the first antenna may be configured to operate in the PS bands at 220, 470 and 800 MHz.

The second antenna may be physically much smaller compared to the first antenna, and may include a small monopole 912, a small ground wall 914, and capacitor patch 910. As described above, the single coaxial cable 908 may feed both the first and second antennas. In the example of FIGS. 9A and 9B, the capacitor patch 910 has dual functionality—it provides a capacitive feed for the first antenna and acts as a top patch for the second antenna. In some embodiments, the small ground wall 914 and the capacitor patch 910 provide the inductance and capacitance, respectively, to match the small monopole. The dimensions of the second antenna may be configured to operate in the 4.9 GHz PS band.

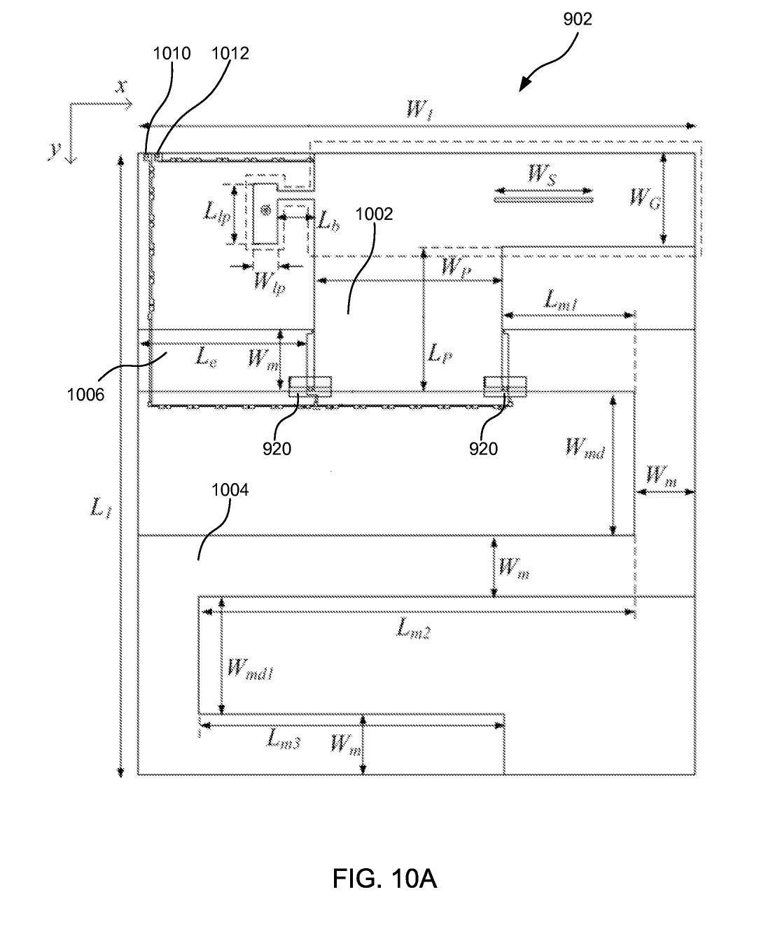

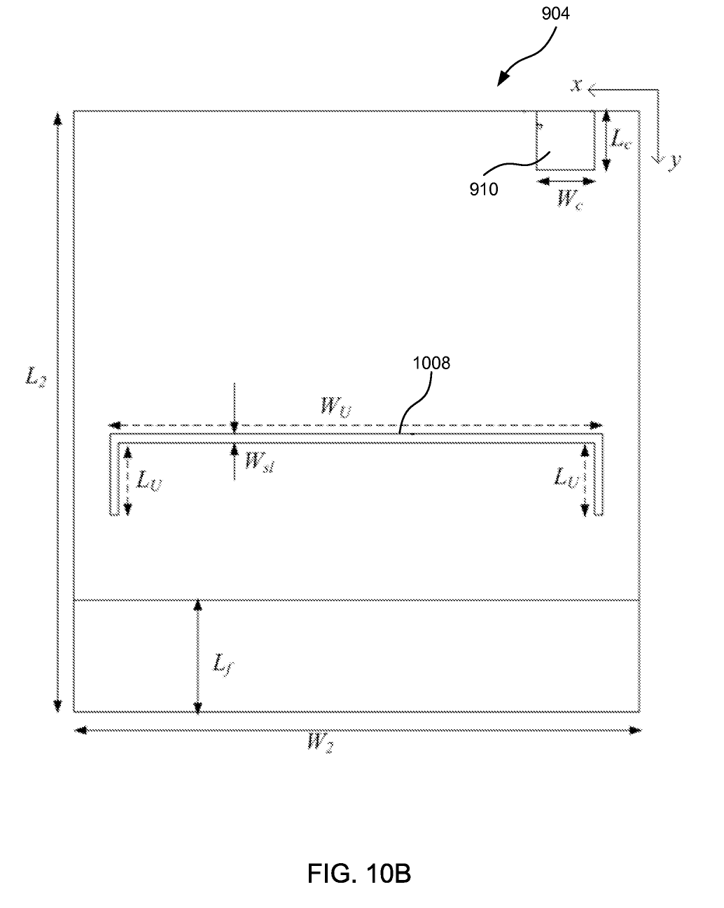

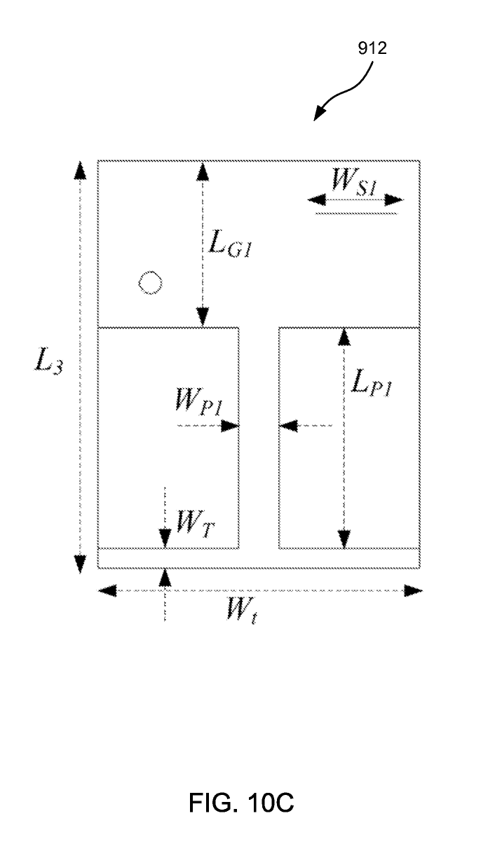

FIGS. 10A-10C illustrate a two-dimensional layout of the various components in an example broadband antenna having a reconfigurable ground plane architecture. FIG. 10A illustrates the reconfigurable ground layer of an example broadband antenna according to the techniques introduced here. The reconfigurable ground layer 902 includes a pole-structure 1002, a meander 1004, and an extra arm 1006, which are physically connected or disconnected by RF MEMS switches 920. In one embodiment, the pole-structure 1002, the meander 1004, and the extra arm 1006 make up a T-shape structure that operates in a similar fashion to the stepped T-shaped structure discussed above. The example antenna of FIGS. 10A-10C may be configured to the operate in the 220 and 470 MHz bands when the RF MEMS switches 920 are in an ON state, i.e., when the pole-structure 1002, meander 1004, and the extra arm 1006 are physically or electrically connected to each other. Whereas, the antenna may be configured to operate in the 800 MHz band when the RF MEMS switches 920 are in an OFF state. The example reconfigurable ground layer of FIG. 10A further includes bias lines 1010 and 1012 which provide DC voltage to actuate the RF MEMS switches 920. In the example embodiment of FIG. 10A, both MEMS switches 920 are controlled by a single bias line. However, other configurations of controlling the switches may be used. As shown, bias line 1010 provides the DC voltage to actuate the RF MEMS switches 920, while bias line 1012 provides the grounding for not only the RF MEMS switches 920, but all of the isolated metallization of the antenna structure. In some embodiments, the bias lines may be delimited by surface mounted components (e.g., inductors and resistors) to mitigate the affect of the bias lines on the performance of the antenna.

FIG. 10B illustrates the top patch of an example broadband antenna according to the techniques introduced here. The top patch includes a U-shaped slit 1008 etched into the top metallization layer of the top patch and the capacitor patch 910 coupled with the bottom of the substrate. The U-shaped slit may be configured to increase the bandwidth in the 800 MHz band. For example, when the pole-structure 1002 is disconnected from the meander 1004 and the extra arm 1006 (i.e., the RF MEMS switches 920 are in an OFF state) the pole structure 1002 may be configured to provide a resonant frequency at 730 MHz and the U-shaped slit 1008 on the top patch 904 may be configured to provide an extra resonant frequency at 820 MHz. FIG. 10C illustrates the small monopole of an example broadband antenna according to the techniques introduced here. Irrespective of the status of the MEMS switches, the antenna always operates in the 4.9 GHz band.

An antenna designed according to the reconfigurable ground layer architecture as introduced herein may provide a very high operational frequency ratio of 22 (4960/220). Example parameters of a design that may achieve these operational characteristics are included below in Table 1. The parameters listed in Table 1 correspond to those parameters shown in FIGS. 10A-10C.

TABLE 1

| Par. | Value (mm) | Par. | Value (mm) | Par. | Value (mm) |
|---|---|---|---|---|---|
| L₁ | 178 | L_{Ip} | 17 | L_{b} | 10.3 |
| W₁ | 160 | W_{Ip} | 7 | W_{S} | 28 |
| L_{P} | 41.4 | Lₑ | 48.5 | W_{G} | 26.8 |
| W_{P} | 54 | Lₘ₁ | 36 | Wₘ | 17.5 |
| W_{md} | 41.3 | Lₘ₂ | 125 | L₂ | 134 |
| W_{md1} | 33.7 | Lₘ₃ | 87.5 | W₂ | 126 |
| L_{U} | 110 | L_{f} | 25 | L_{C} | 13.2 |
| W_{U} | 16 | L_{G1} | 8.3 | W_{C} | 12.7 |
| L₃ | 20.2 | Wₜ | 16 | W_{S1} | 4 |
| Lₚ₁ | 11 | Wₚ₁ | 2 | W_{sI} | 2 |
| W_{T} | 1 | h₁ | 16.7 | h₂ | 10.1 |

In certain embodiments, the antenna structures described herein may be fabricated through copper layer removal of a RO4003C™ substrate via mechanical etching to define the planar geometrical features of the antenna. Particularly, this process may be used to define the top patch, the capacitive feed, the stepped T-shape structure, the reconfigurable ground plane, the small monopole, etc. In certain embodiments, the top patch, the small monopole, and capacitive feed may be formed using a substrate with a thickness of d₁=0.813 mm, and the stepped T-shape structure, reconfigurable ground plane, and vertical wall may be formed using separate substrates with a thickness of d₂=1.525 mm. Once fabricated, the individual parts of the antenna along with the coaxial feed may be mechanically coupled (e.g., soldered) to obtain the 3-dimensional antenna architecture illustrated in the figures. In one embodiment, air provides a dielectric layer between the ground plane and the top patch of the various antennas disclosed herein. However, in other embodiments, various other dielectric materials with dielectric constants close to that of air (e.g., many types of foam) may be used to separate the antenna layers and also provide structural rigidity.

The components of the disclosed embodiments, as generally described herein, could be arranged and designed in a wide variety of different configurations. For example, while the stepped T-shape antenna architecture is disclosed as producing a dual-resonance behavior to achieve broad bandwidth performance, antenna architectures designed to produce other multiple resonance behaviors (e.g., multiple-stepped antenna architectures) are also contemplated. Accordingly, the above detailed description of the embodiments of the systems and methods of the disclosure is not intended to limit the scope of the disclosure, but is merely representative of possible embodiments of the disclosure. In addition, the steps of any disclosed method do not necessarily need to be executed in any specific order, or even sequentially, nor do the steps need be executed only once, unless otherwise specified.

Similarly, in the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, inventive aspects lie in a combination of fewer than all features of any single foregoing disclosed embodiment. Changes may be made to the details of the above-described embodiments without departing from the underlying principles set forth herein.

What is claimed is:

1. A broadband antenna comprising:
a top patch having a top metallization layer, a capacitor patch, and a top patch substrate between the top metallization layer and the capacitor patch;
a T-shaped ground layer disposed below the top patch; and
a ground wall electrically coupling the top metallization layer with the T-shaped ground layer.

2. The broadband antenna of claim 1, wherein the T-shaped ground layer is reconfigurable.

3. The broadband antenna of claim 1, wherein the top metallization layer includes a U-shaped slit.

4. The broadband antenna of claim 1, wherein the top metallization layer includes a linear taper.

5. The broadband antenna of claim 1, further comprising:
a second antenna disposed between the top patch and the T-shaped ground layer, the second antenna comprising:
a second top patch, wherein the capacitor patch provides the second top patch;
a monopole-shaped ground layer; and
a second ground wall electrically coupling the second top patch with the monopole-shaped ground layer.

6. The broadband antenna of claim 1, wherein the dielectric material comprises a substrate material having a dielectric constant in the range of ∈ᵣ=3.38 to ∈ᵣ=3.55.

7. The broadband antenna of claim 1, wherein the broadband antenna is configured to be fed by a coaxial cable having an inner conductor electrically coupled with the capacitor patch and an outer conductor electrically coupled to the T-shaped ground layer.

8. The broadband antenna of claim 1, wherein the broadband antenna is configured to operate in standard public safety wireless communication bands.

9. The broadband antenna of claim 1, wherein the broadband antenna is configured to operate in standard long-term evolution wireless communication bands.

10. The broadband antenna of claim 1, wherein the broadband antenna is configured to operate from 221 MHz to 861 MHz.

11. The broadband antenna of claim 1, wherein the second antenna is configured to operate at 4.9 GHz.

12. A broadband antenna comprising:
a top patch having a top metallization layer, a capacitor patch, and a top patch substrate between the top metallization layer and the capacitor patch;
a reconfigurable ground layer including a microelectromechanical switch to activate portions of the reconfigurable ground layer;
a shorting wall electrically coupling the top patch with the reconfigurable ground layer, wherein the top patch is fed by a capacitive feed comprising a coaxial cable coupled with the capacitor patch.

13. The broadband antenna of claim 12, wherein the top metallization layer includes a U-shaped slit.

14. The broadband antenna of claim 12, wherein the top metallization layer includes a linear taper.

15. The broadband antenna of claim 12, further comprising:
a second antenna disposed between the top patch and the reconfigurable ground layer, the second antenna comprising:
a second top patch, wherein the capacitor patch provides the second top patch;
a monopole shaped ground layer; and
a second ground wall electrically coupling the second top patch with the monopole shaped ground layer.

16. The broadband antenna of claim 12, wherein the dielectric material comprises a substrate material having a dielectric constant in the range of ∈ᵣ=3.38 to ∈ᵣ=3.55.

17. The broadband antenna of claim 12, wherein the broadband antenna is configured to operate in standard public safety wireless communication bands.

18. The broadband antenna of claim 12, wherein the broadband antenna is configured to operate in standard long-term evolution wireless communication bands.

19. The broadband antenna of claim 12, wherein the broadband antenna is configured to operate from 221 MHz-861 MHz.

20. The broadband antenna of claim 12, wherein the second antenna is configured to operate at 4.9 GHz.

21. A broadband antenna comprising:
a top patch;
a T-shaped ground layer disposed below the top patch; and
a ground wall electrically coupling the top metallization layer with the T-shaped ground layer, wherein the top patch, the T-shaped ground layer, and the ground wall are configured to create a resonant frequency in multiple bands.

22. The broadband antenna of claim 21, wherein the T-shaped ground layer is configured to behave as a quarter-wave monopole at a first frequency and a second frequency.

23. The broadband antenna of claim 22, wherein the first frequency is 390 MHz.

24. The broadband antenna of claim 22, wherein the second frequency is 585 MHz.

25. The broadband antenna of claim 21, further comprising an active component configured to reconfigure the ground layer to produce additional resonant frequencies.

26. The broadband antenna of claim 21, further comprising a second antenna disposed between the top patch and the T-shaped ground layer, the second antenna configured to produce an additional resonant frequency.
